(19) United States
(12) Patent Application Publication
(10) Pub. No.: US 2009/0037272 A1
(43) Pub. Date: Feb. 5, 2009

(54) System and method for purchasing values generation, tracking and expenditure

(76) Inventor: Alexander Boris Demushkane, Monterey, CA (US)

Correspondence Address: PATRICK REILLY, P.O. BOX 7218, SANTA CRUZ, CA, 95061-7218, US

(21) Appl. No.: 11/881,999

(22) Filed: Jul. 30, 2007

(51) Int. Cl. G06Q 30/00

(52) U.S. Cl. 705/14

(57) ABSTRACT

A system, method and computer-readable medium are provided for generating, tracking and spending credits, i.e. purchasing values, that are earned by making purchases of goods and services from a group of participating merchants. The spending of the purchasing values is limited to a predetermined geography, whereby localized purchasing of goods and services is encouraged and rewarded. In one version, the participating merchants receive advertising services in exchange for issuing and accepting purchasing values.

### FIELD OF THE INVENTION

The present invention relates to information technology systems that maintain databases and enable searches for credit information contained within the database. The present invention more particularly relates to enabling the management by an information technology system of accounts and transactions.

### BACKGROUND OF THE INVENTION

Customer loyalty programs are growing increasingly common and important in consumer, business to business, and financial service spheres of economic activity. Many of these programs use portable cards that may be fitted into a pants pocket or a wallet. The integration of portable loyalty cards with established credit and debit accounts is also included in certain marketing strategies.

In the conventional art of financial transaction management, software databases are often made accessible via a communications network that may include a telephony system, a computer network, and or the Internet. A software database is a collection of information stored in an information technology system in a systematic way, such that a user may employ a computer to retrieve information from the database. A software program used to manage and query a software database is known as a database management system (hereafter “DBMS”).

In the conventional art, most databases are organized as either a relational database or as an object-oriented database. A relational database (hereafter “RDBS”) stores data in a structure consisting of one or more tables of rows and columns, which are typically interconnected. Each RDBS row corresponds to a record, i.e., a tuple, and each RDBS column correspond to an attribute, i.e., a field, in a record. A Structured Query Language (hereafter “SQL”) is used for data definition, data management, and data access and retrieval from a RDBS.

Many public and private enterprises maintain federated databases enabled by information technology infrastructures that support numerous databases. A federated database might include combination of (1.) an object oriented database, (2.) an IBM DB2 Universal Database™ server (in Linux, UNIX®) marketed by IBM Corporation of Armonk, N.Y.; (3.) WINDOWS™ operating system environments marketed by Microsoft Corporation of Redmond, Wash.; and (4.) multiple data sources to which the client query application sends queries.

The volume of electronic payment transactions that rely upon software data bases accessible via communications networks, and that are executed with credit cards, debit cards (on-line and off-line), and ATM cards at the point of sale (hereafter “POS”) has reached an annual level of approximately 45 billion point-of-sale (POS) transactions annually which represent over $1.1 Trillion in transactions. The transaction volume of electronic transactions is continuing to grow readily. Debit and checks currently represent 63% of total non-cash payments at the POS today and this percentage is expected to grow to 70% by 2010. Currently 18 billion checks are processed annually with merchants incurring an estimated $23 billion in check handling and fraud costs. As debit cards gain wider acceptance, the use and volume of checks is expected to decline. Debit transactions are surpassing credit transactions at the POS. It is anticipated that by 2010, non-cash POS transactions are expected to grow to 67 billion transactions with a transaction value of $4.6 Trillion (Nilson Report, Star System Inc.-Tower Group). The policies and operation for executing electronic transactions is currently determined by issuing banks which charge substantial transaction fees for processing these non-cash transactions. The fees collected for executing the transactions are borne by the merchants, typically retailers, and these transaction fees have continued to escalate. Even current automated clearing house (ACH) “check-based” debit cards such as “VISA Check”™ by VISA® and “Master Money”™ by MasterCard® subject the retailers to the same rate schedule as conventional VISA, MasterCard, and other similar credit card products.

The transaction fee paid by the merchant for a moderately sized purchase of $60 can approach $0.75. It will be appreciated that since a large percentage of point of sale transactions are executed using credit cards, debit cards, and ATM cards, the overall cost per transaction may significantly impact merchant profitability. The trend has been toward increasing use of debit instruments in relation to checks and credit card instruments, while the transaction cost for these instruments continues to increase, at the expense of merchants that accept the cards for payment.

As conventional debit, credit, and ATM transaction instruments are under the control of issuing banks, the merchants must follow the dictates of the banking institutions and consequently have no control over the process, and furthermore no access to consumer purchase information within the associated databases. As a result, the ability of the merchants to establish retailer loyalty and frequent buyer programs is severely diminished.

Therefore, a need exists for a customer credit program that includes the monitoring and/or accounting of point of purchase transactions while optionally enabling a potential of maintaining user anonymity in certain applications or embodiments of the program.

The prior art teaches of efforts to expand the use of card based or account based transaction management systems, to include U.S. Pat. No. 7,104,443 presents a method and system for facilitating electronic funds transactions; US Patent Application Serial No. 20030200179 teaches a method, apparatus and program for making payments in any currency through a communication network system using pre-paid cards; US Patent Application Serial No. 20020077904 discloses a loyalty program; US Patent Application Serial No. 20060118611 presents loyalty program enrollment systems and methods; US Patent Application Serial No. 20060006224 presents a money transfer service with authentication; and US Patent Application Serial No. 20030018553 discloses a system for automatically generating a list of merchants in conjunction with the generation of gift certificate.

The entire disclosures of each and every patent mentioned in this present disclosure, to include U.S. Pat. No. 7,104,443 and US Patent Application Serial No.'s 20030200179; 20020077904; 20060118611; 20060006224; and 20030018553 as noted above, are incorporated herein in entirety by reference and for all purposes.

### SUMMARY OF THE INVENTION

Towards this object and other objects that will be made obvious in light of this disclosure, a first preferred embodiment of the method of the present invention provides a first method enabled by an information technology system a managing purchasing values earned by purchasing goods and services from a plurality of subscribing merchants. The first method includes the aspects of assigning an account number; associating the account number with an object, such as a physical card; issuing purchasing values as earned by making purchases of goods and/or services associated with the assigned account number from at least one of the subscribing merchants; and enabling expenditures of the earned purchasing values in exchange for goods services within a predetermined geography.

The limitation of the expenditure of purchasing values distinguishes certain alternate preferred embodiments of the method of the present invention, in that the prior art teaches away from limiting the expenditure of purchasing values on a geographic basis.

One or more expenditures of the earned purchasing values may require a physical presentation of the object, e.g. a card, at a merchant location within the predetermined geography. The object may include a machine readable memory, and the account number and issued purchasing values may be written into, and machine readable, from the memory in various alternate preferred embodiments of the method of the present invention.

Various still alternate preferred embodiments of the method of the present invention may include one or more of the following aspects: (a.) enabling a subscribing merchant to earn advertising services in return for issuing purchasing values; (b.) associating the assigned account number with a unique database record; (c.) recording the issued purchasing values associated with the assigned account number in the associated unique data base record; (d.) enabling one or more subscribing merchants to issue uniquely identifiable purchasing values; (e.) limiting expenditures of uniquely identifiable purchasing values the purchases of goods and services marketed by the at least one subscribing merchant; (f.) limiting the purchases of goods and services with the purchasing values to goods and services marketed at single retail sales location of the at least one subscribing merchant; and (g.) credits may be earned by performing services or goods, whereby the earned credits are issued and transferred by a first party to a second party as compensation for the goods and/or services provided by a second party.

Certain other alternate preferred embodiments of the method of the present invention may additionally or alternatively comprise one or more of the following aspects: (a.) provision and use of a first type of purchasing values that may be exchanged for goods and services with all subscribing merchants; (b.) provision and use of a second type of purchasing values that may be exchanged at a subset of all subscribing merchants; (c.) limiting expenditures of the second type of purchasing values to the exchange of goods and services marketed at a retail sales location of a single subscribing merchant; (c.) limiting the expenditure of the second type of purchasing values to the exchange of goods and services marketed at only one retail sales location of the a single subscribing merchant.

Certain yet additional alternate preferred embodiments of the method of the present invention provides a method partly enabled by a computer network having a purchasing value data base, a method for exchanging purchasing values, wherein the method includes one or more of the aspects of (a.) assigning a plurality of unique account numbers; (b.) associating each account number with a unique physical card and a unique database record of the purchasing value data base; (c.) storing purchasing values assigned to each unique account number in each associated unique data base record; (d.) enabling the transfer of purchasing values among each unique data base records; (e.) enabling expenditures of earned purchasing values in exchange for goods services within a predetermined geography, wherein at least one unique database record includes permission to automatically exchange purchase value; (f.) providing database records that and permissions to automatically exchange purchase values issued by an identified subscribing merchant; (g.) providing permission to automatically exchange purchase values for purchase values issued by an identified subscribing merchant; and (h.) enabling automated transfer of purchasing values in accordance with user directed preferences of types of purchasing values.

Certain even alternate preferred embodiments of the method of the present invention provide a computer-readable medium containing machine-executable instructions for directing an information technology system to execute the one or more aspects of the various alternate preferred embodiments of the method of the present invention as disclosed herein.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 is a schematic drawing of an electronic communications network that includes a computational system providing a software database function;

FIG. 2 is a detailed schematic of the computational system of FIG. 1;

FIG. 3 is an entity diagram of database software maintained on or accessible to the computational system and/or the electronic communications network of FIG. 1;

FIG. 4 is a schematic diagram of an electronic record that may be stored in whole or in part within a computer-readable media or a software database of FIG. 3;

FIG. 5 is a flow chart of the creation and application of a value account associated with a record of the database software of FIGS. 1, 2, 3 and 4;

FIG. 6 is a flowchart of an automated trade of values between database records of FIGS. 1, 2, 3 and 4;

FIG. 7 is a schematic diagram of a trading table wherein offers for trading values of the records of FIGS. 1, 2, 3, and 4 are stored and applied;

FIG. 8 is a process diagram of a second alternate preferred embodiment of the method of the present invention, or second method, that may be implemented by means of the electronic communication network of FIG. 1, the computational system of FIG. 2, and the software of FIGS. 3 through 5;

FIG. 9 is a flow chart of a an optional transaction analysis module of the system software of FIG. 3;

FIG. 10 is a flow chart of an optional aspect of the transaction analysis module of FIG. 9 and the system software of FIG. 3;

FIG. 11 is a geographic table TG, or geo table TG, that may be used by the computer of FIG. 2, and/or a database system, a workstation , or the network of FIG. 1 in enabling or supporting the process of the second method of FIG. 8 and/or FIG. 9;

FIG. 12 is a flow chart of additional optional process steps that may be implemented by the transaction analysis module of FIG. 9,

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

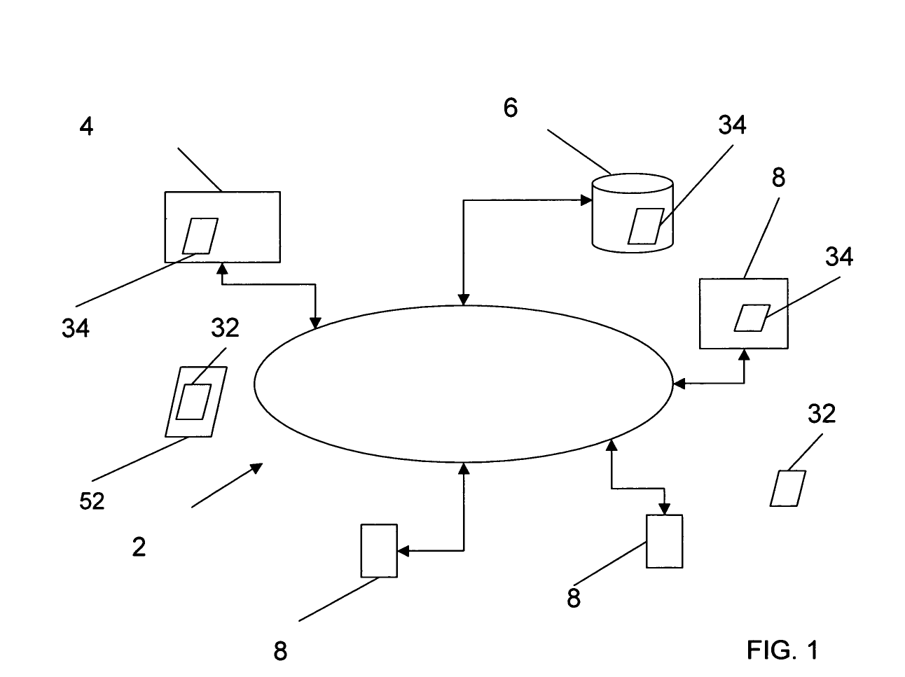

Referring now generally to the Figures and particularly to FIG. 1, FIG. 1 is a schematic drawing of an electronics communications network 2 that includes a point-of-sale computational system 4 (hereafter “POS computer” 4) providing a software database function. The electronics communications network 2 (hereafter “network” 2) includes a plurality of database systems 6 and computer workstations 8. The POS computational system 4 (hereafter “computer” 4), the database systems 6, and the computer workstations 8 may comprise, or be comprised within, (1.) a personal computer configured for running WINDOWS XP™ operating system marketed by Microsoft Corporation of Redmond, Wash., (2.) a computer workstation configured to run, and running, a LINUX or UNIX operating system, and/or (3.) other suitable computational system known in the art configured for software database management and accessibility. In particular, the computer 4 may be a computer system, such as (a.) a VAIO FS8900™ notebook computer marketed by Sony Corporation of America, of New York City, N.Y., (b.) Posiflex Jiva 5815™ point of sale computer station marketed by Posiflex Technologies, Inc., or (c.) other suitable computational system known in the art, and configured for wireless and/or landline connectivity with the Internet and/or the World Wide Web.

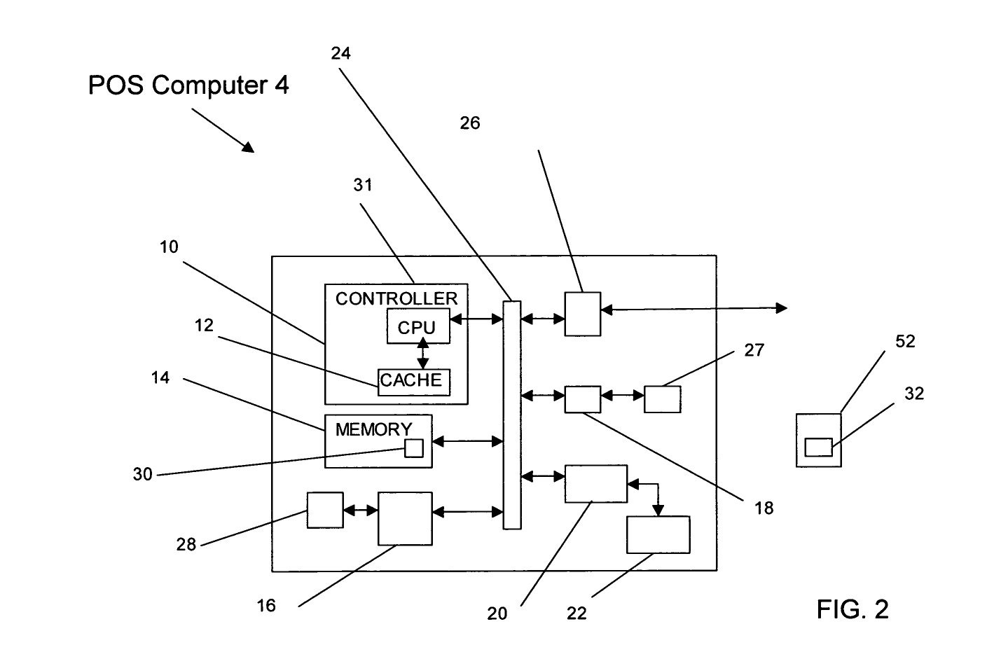

Referring now generally to the Figures and particularly to FIG. 2, FIG. 2 is a detailed schematic of the POS computer 4 of FIG. 1. The POS computer 4 includes a central processing unit 10 (hereafter “CPU” 10), a cache memory of the CPU 12, a system memory 14, a data input device interface 16, a display device interface 18, a media reader interface 20, a media writer/reader 22, an internal communications bus 24, and a network communications 26. The CPU 10, the system memory 14, the data input device 16, the display device interface 18, the media reader interface 20, and the network interface 26 are communicatively coupled by means of the internal communications bus 24. The network communications interface 26 communicatively couples the computer 4 with the network 2 via the CPU 10 and the internal communications bus 24. The media reader interface 20 communicatively couples the media writer/reader 22 with the CPU 10 and the system memory 14 by means of the internal communications bus 24. The display device 18 interface communicatively couples a display device 27, e.g., a liquid crystal display device, to the CPU 10 via the internal communications bus 24. The data input device interface 16 communicatively couples an input device, such as a keyboard and computer mouse module 28 with the CPU 10 via the internal communications bus 24. The system memory 14 stores a system software 30 of the computer 4. The CPU 10 and the cache memory may be comprised within a unified controller 31.

The media writer/reader 22 is configured to read a computer-readable and machine executable instructions stored within a computer-readable medium 32 and transmit the read instructions to the CPU 10 and the system memory 14. The terms “computer-readable medium” and “computer-readable media” as used herein refer to any suitable medium known in the art that participates in providing instructions to the network and/or the computer. Such a medium may take many forms, including but not limited to, non-volatile media, volatile media, and transmission media. Non-volatile media includes, for example, optical or magnetic disks, such as may be comprised within the system memory.

Volatile media includes dynamic memory. Transmission media includes coaxial cables, copper wire and fiber optics. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer system can read.

Various forms of computer-readable media 32 may be involved in carrying one or more sequences of one or more instructions to the network for execution. For example, the instructions may initially be carried on a magnetic disk of a remote server. The remote server can load the instructions into its dynamic memory and send the instructions over a telephone line using a modem. A modem local to or communicatively linked with the network can receive the data on the telephone line and use an infra-red transmitter to convert the data to an infra-red signal. An infrared detector can receive the data carried in the infrared signal and appropriate circuitry can provide the data to the network.

It is understood that the workstations 8 and database systems 6 of the network may comprise some or all of the aspects and elements of the POS computer 4 disclosed herein optionally along with additional suitable aspects and elements known in the art

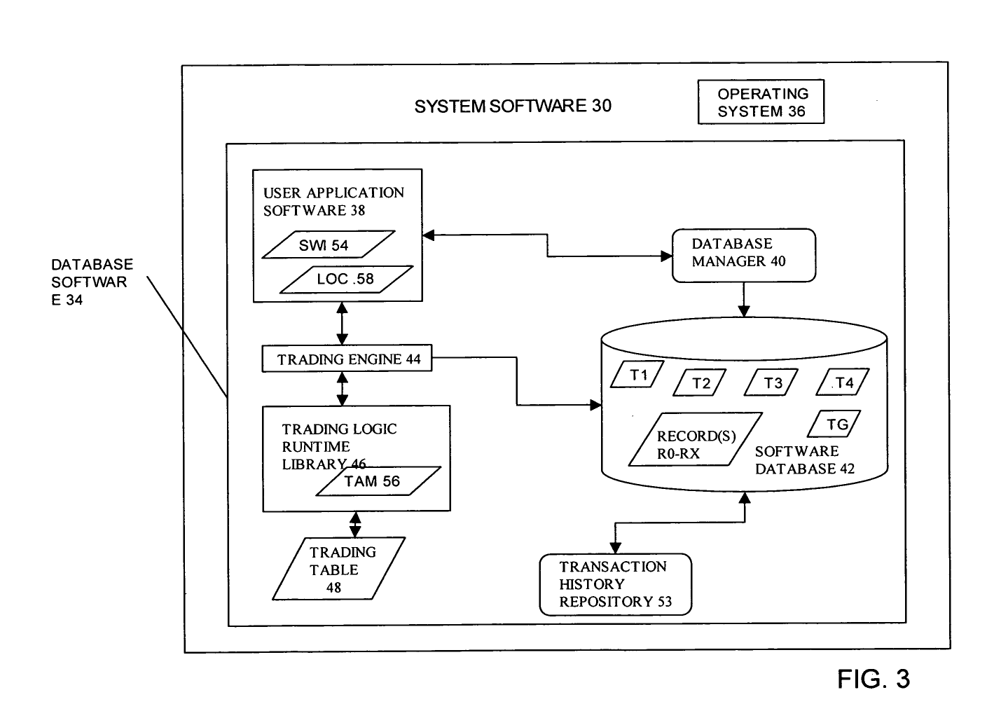

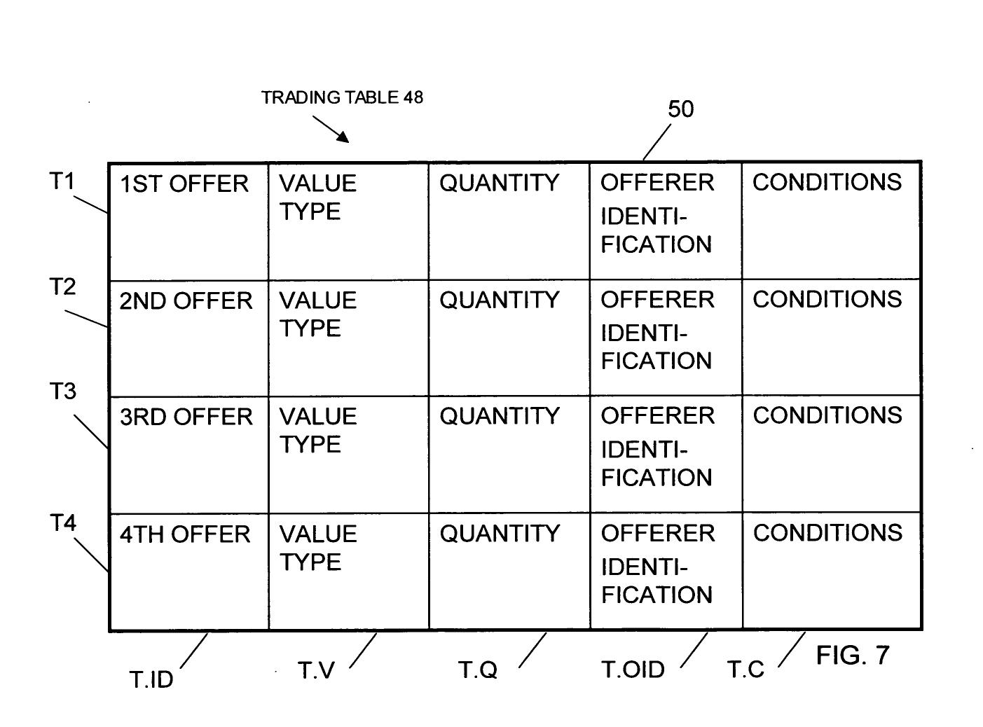

Referring now generally to the Figures and particularly to FIG. 3, FIG. 3 is an entity diagram of a database software 34 of the system software 30 that is maintained on or accessible to the computer 4 and/or the network 2 of FIG. 1. The computer 4 or network 2 may host system software 30 and operating system 36 that includes user application software 38 useful to manage input and output communications between the POS computer 4, database system 6 and/or workstation 8 hosting the system software 30. A database manager 40 accepts queries, instructions, commands and data from a computer 4, 6, or 8, or the network 2, and thereupon accesses and modifies a software database 42 in compliance with the received queries, instructions, commands and data. Each record R0-RX is associated with a schema of a software object or other suitable data structure known in the art, whereby an instantiation of a record R0-RX is performed according to a schema associated with the instant record R0-RX. The database manager 40 (hereafter “DBMS”) enables commands and queries provided from or sourced by the user application software 38 or a trading engine 44 to be applied to the records R0-RX of the software database 42. A trading engine logic 46 directs the trading engine 44 to modify the records R0-RX in accordance with information regarding offers of stored within a trading table 48 of FIG. 7, to include value types and quantities, conditions placed on an offer to trade values, and an identification 50 of the offerer. The offerer identification 50 may merely be a reference to a record R0-RX, whereby the anonymity of the user of a card 52 associated with the record is maintained. A record of transactions associated with a particular record R of records R0-RX may be maintained in a transaction history repository 53.

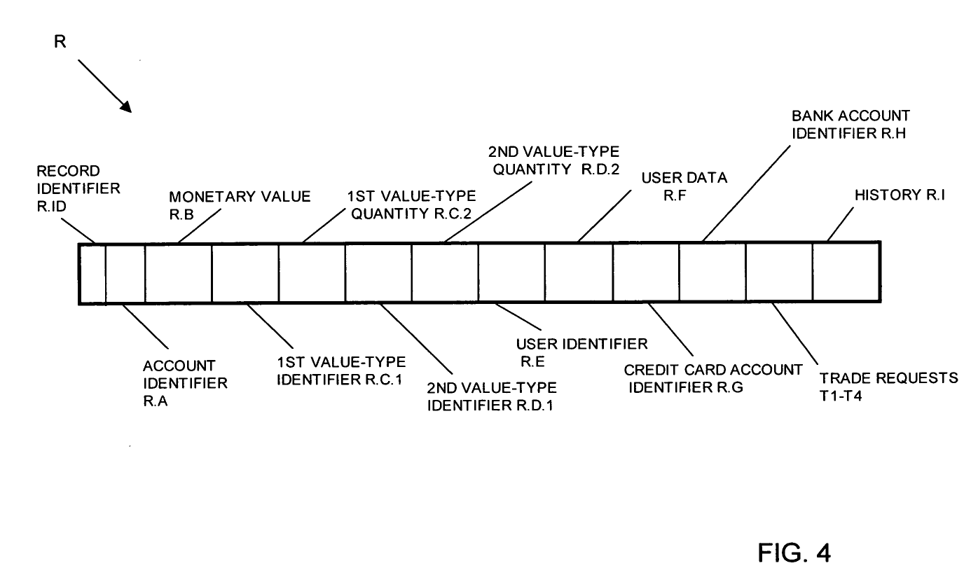

Referring now generally to the Figures and particularly to FIG. 4, FIG. 4 is a schematic diagram of an electronic record R of the plurality of records R0-RX that may be stored in whole or in part within the computer-readable media 32 or a software database 42 of FIG. 3. Each record R0-RX includes a plurality of data fields containing data such as a record identifier A record identifier R.ID uniquely identifies the record within the database software 34. An account identifier R.A uniquely identifies the account, which may have one or more record identifiers associated with it. A monetary value R.B specifies the monetary credit of the account identified by account identifier R.A. A first value-type identifier R.C.1 identifies the type of credit; for example, a credit account issued and honored by a specific coffee shop. A second value-type quantity R.C.2 specifies the quantity of credit possessed by the account and of the type indicated by the first value-type identifier R.C.1. A second value-type identifier R.D.1 identifies the type of credit; for example, a credit account issued and honored by a specific clothing store. A second value-type quantity R.D.2 specifies the quantity of credit possessed by the account and of the type indicated by the second value-type identifier R.D.1. A user identifier R.E associates the account with the user; for example, by the user's social security number. A user data R.F contains information about the user; for example, the user's date of birth. A credit card account identifier R.G identifies a particular credit account for example, a Visa™ or MasterCard™ credit account number. A bank account identifier R.H may be a user's bank account number. A plurality of trade requests T1-T4 is discussed below in reference to FIG. 7. A history R.I consists of historical data, which may include records of credit expended from the user's account.

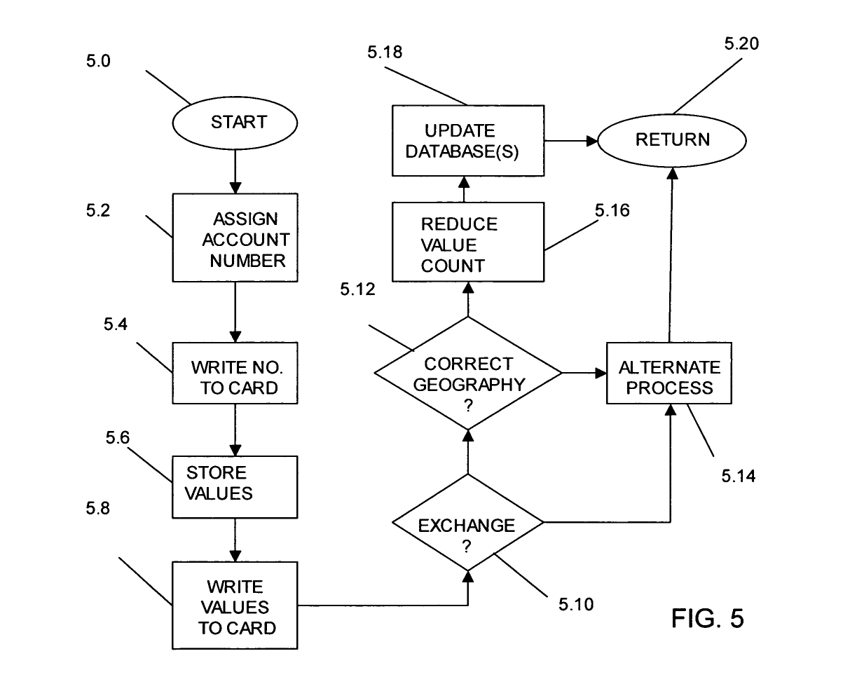

Referring now generally to the Figures and particularly to FIG. 5, FIG. 5 is a flow chart of the creation and application of a value account associated with a record R of the database software 34 of FIGS. 1, 2, 3 and 4. In step 5.2 the record R is assigned an account number; in step 5.4 the account number is written onto the computer-readable media 32 of a card 52; in step 5.6 values types and quantities are stored in the record R. The value types and quantities written the record R in step 5.6 might include values and quantities issued by a first party in compensation for goods and/or services received from a second party. In step 5.8 the information of record R is written onto the computer-readable media 32 of the card 52. The information written the electronic media of the card in step 5.8 might include values and quantities issued by a first party in compensation for goods and/or services received from a second party. In step 5.10 the POS computer 4 determines whether a user of the card is requesting an exchange of values for one or more goods and/or services. In step 5.12 the POS computer 4, or other database system 6 or workstation 8 hosting the system software 30, determines whether the values R.B, R.C.1, R.D.1, R.G, R.H, intended for exchange by the user in step 5.10 are valid in the geography applicable to the requested exchange of step 5.10. In step 5.14 the hosting computer 4, 6 or 8 proceeds on to other information processing or computational activity, but in alternate step 5.16 the relevant value quantity R.B, R.C.2, R.D.2, R.G, R.H indicated in step 5.10 is reduced to effect the exchange and in step 5.18 the relevant value quantity count of the associated record R is updated and reduced.

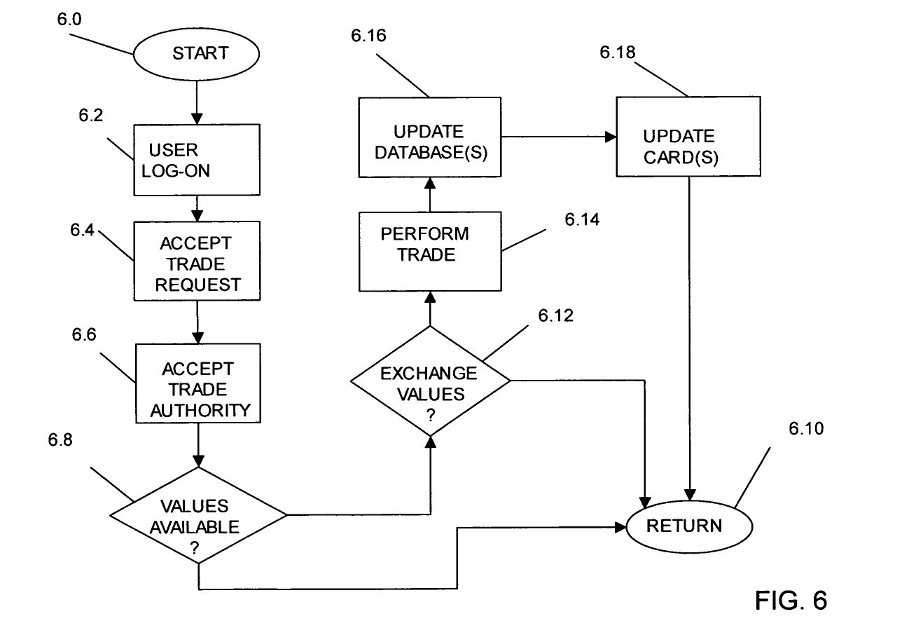

Referring now generally to the Figures and particularly to FIG. 6, FIG. 6 is a flowchart of an automated trade of values between database records R0-RX of FIGS. 1, 2, 3 and 4. In step 6.2 a user logs on to the network 2. In step 6.4 the network 2 accepts a trade request from the user. In step 6.6 the network 2 accepts the conditions and authority under which a value trade may be affected as input by the user and/or read from the card 52. In step 6.8 the network 2 determines whether the user has identified an account having a value type and quantity sufficient to enable a trade; if not, the network exits the process in step 6.10. In step 6.12 the network determines whether a corresponding the trading table of FIGS. 3 and 7 contains a corresponding trade offer. In step 6.14 a trade is effected, and values are exchanged between the two relevant records R0-RX. In step 6.16 the records R0-RX as stored in the network software databases 42 are updated to reflect the trade of step 6.14. In step 6.18 the cards 52 associated with the records R0-RX updated in step 6.16 are updated to reflect the trade of step 6.14.

Referring now generally to the Figures and particularly to FIG. 7, FIG. 7 is a schematic diagram of a trading table 48 table of FIG. 3, wherein offers for trading values of the records R0-RX of FIGS. 1, 2, 3, and 4 are stored and applied. Each trade offer T1-T4 includes an offer identifier T.ID; a value type T.V; a quantity T.Q; an offerer identifier T.OID; and conditions T.C under which the trading logic 46 of FIG. 3 will authorize a trade.

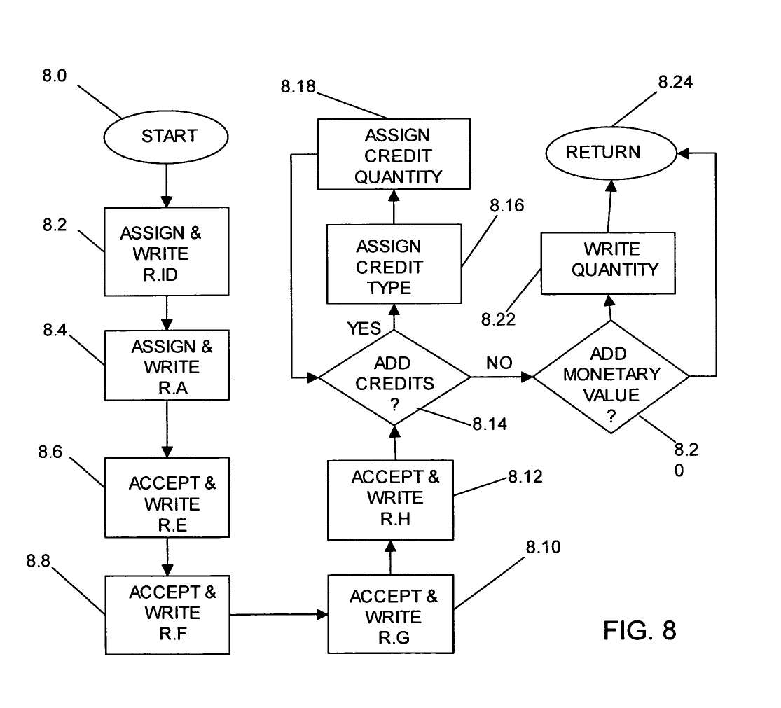

Referring now generally to the Figures and particularly to FIG. 8, FIG. 8 is a process diagram of a second alternate preferred embodiment of the method of the present invention, or second method, that may be implemented by means of the electronic communication network 2 of FIG. 1, the computer 4 of FIG. 2, and the software of FIGS. 3 through 5. In steps 8.0 through 8.24 a card 52 is initialized by programming the computer-readable medium 32 of the card 54, hereafter “card medium” 32. In step 8.0 the card 52 is inserted into the media reader 22 of the computer 4. In step 8.2 an account initiation module 54, hereafter “SWI” 54 of the system software 30 directs the computer 4 to write information onto the card media 32 by means of the media writer/reader 22 and populates a record R that may be partially or wholly stored in the card media 32and/or within the software database .x. In step 8.2 the SWI 54 assigns the card media 32 is assigned a record identifier R.ID. In step 8.4 the SWI 54 associates an account identifier R.A with the record identifier R.A. In optional step 8.6 a user is associated with the record identifier R.ID and the account identifier R.A by writing a user identifier, e.g., a tax identification number or a driver's license number, as the user identifier R.E. The SWI 54 may direct the computer 4 to write information related the user associated with the user identifier R.E in the record R as user data R.F in optional step 8.8. User data R.F may include, as examples and not necessarily, a name and residence address of the user. In optional step 8.10 the computer 4 may write a credit card account number as the credit data R.G. In optional step 8.12 the computer 4 may write a bank account number as the bank data R.H. It is understood that the data written into the record R and for the data R.E-R.H of steps 8.6 through 8.12 may be supplied by a user or a third party via the network 2, the input device 28, the computer 4, and/or an other computer-readable medium 32.

In step 8.14 the SWI 54 determines whether to add or transfer credits into the record R. If the SWI 54 determines that credits shall be added to the record R, the computer 4 proceeds from step 8.14 to execute step 8.16 and write into the record R the type of credits being written into R and therefrom to step 8.18 to write in a quantity of credits into the record R, where, for example the type of credits of step 8.16 might be first value-type credits R.C.1 and the quantity of step 8.18 but be the first value-type quantity R.C.2. The SWI 54 directs the computer 4 from step 8.18 to step 8.14 and to determine whether an additional type of credits might be stored in the record R by executing steps 8.16 and 8.18 in reference to another credit type, e.g., the second value-type credit R.D.1 & the second value-type quantity R.D.2. When the computer 4 determines in step 8.14 that no more credits are to be added to the card media 32, then the SWI 54 directs the computer 4 to proceed from step 8.14 to step 8.20, wherein the computer 4 determines whether a monetary value R.B shall be added to the card media 32. Where computer 4 determines to add a monetary value R.B to the card media 32, the computer 4 proceeds to enter the monetary value R.B into the record R in step 8.22, and therefrom to return to other operations in step 8.24. It is understood that the data written into the record R and for the data R.C.1, R.C.2, R.D.1, R.D.2 & R.B of steps 8.14 through 8.22 may be supplied by a user or a third party via the network 2, the input device 28, the computer 4, and/or an other computer-readable medium 32. It is further understood that each and every workstation 8 or database system 6 may comprise some or all of the hardware and software aspects of the computer 4 as shown in FIGS. 2 through 12, and that the SWI 54 may be distributed among two or more computers 4, database systems 6, and/or workstations 8, e.g. system software 30, whereby one or more steps 8.0 through 8.24 may be enabled, instantiated or executed by two or more electronic devices 4, 6 and/or 8.

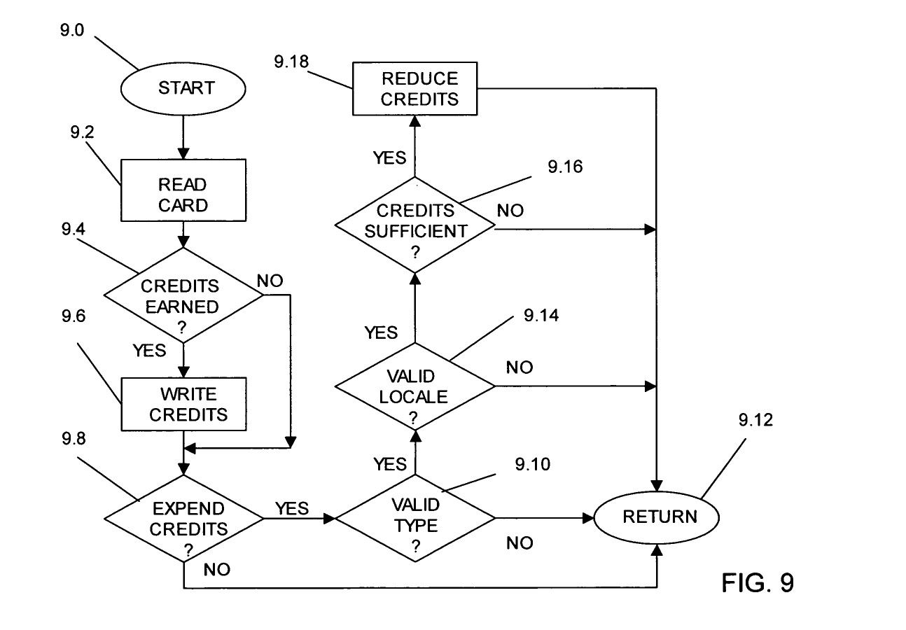

Referring now generally to the Figures and particularly to FIG. 9, FIG. 9 is a flow chart of a transaction analysis module 56 of the system software 30. In step 9.2 the transaction analysis module 56, hereafter “TAM” 56, directs the computer 4 to read the card media 32 via the media writer/reader 22. In step 9.4 the TAM 56 determines whether a bearer of the card 52 has earned credits to be recorded in the record R. When the TAM 56 determines that a bearer of the card has earned credits to be recorded in the record R, the TAM 56 directs the computer 4 to add credits to the record R in step 9.6. It is understood that the record R may be stored wholly or partially within the card media 32 and/or the software database 42 and/or stored in a distributed fashion within the network 2.

In step 9.8 the TAM 56 determines whether a bearer of the card requests to expend credits. When the TAM 56 determines that a bearer of the card 52 has requested to expend credits, the TAM 56 directs the computer 4 to proceed from step 9.8 to step 9.10. When the TAM 56 determines in step 9.8 that no request to expend credits has been received from a bearer of the card 52, the TAM 56 directs the computer 4 to proceed from step 9.8 to step 9.12 and therefrom to proceed to other operations. It is understood that a user may inform the POS computer 4 of a card bearer's request to expend credits, or direct the TAM 56 to add credits in step 9.8, to a record R of the plurality of records R0-RX, by means of the input device 28, an other computer-readable media 32, and/or the network 2.

In step 9.10 the TAM 56 determines whether the record R associated with or stored partially or wholly within the card media 32 has credits stored of a type valid for expenditure by a merchant associated with the computer 2. When the TAM 56 determines in step 9.10 that the record R associated with or stored partially or wholly within the card media 32 has credits stored of a type valid for expenditure by the merchant associated with the computer 4, the TAM 56 directs the computer 4 to proceed on from step 9.10 and to execute step 9.14. When the TAM 56 determines in step 9.10 that the record R associated with or stored partially or wholly within the card media 32 does not have credits stored of a type valid for expenditure by the merchant associated with the computer 4, the TAM 56 directs the computer 4 to proceed from step 9.8 to step 9.12 and therefrom to proceed to other operations.

In step 9.14 the TAM 56 determines whether the record R associated with or stored partially or wholly within the card media 32 has credits stored of a type valid for expenditure by a locale, e.g. a zip code designation, associated with the computer 4. When the TAM 56 determines in step 9.14 that the record R associated with or stored partially or wholly within the card media 32 has credits stored of a type valid for expenditure by the locale associated with the computer 4, the TAM 56 directs the computer 4 to proceed on from step 9.14 and to execute step 9.16. When the TAM 56 determines in step 9.14 that the record R associated with or stored partially or wholly within the card media 32 does not have credits stored of a type valid for expenditure by the locale associated with the computer 4, the TAM 56 directs the computer 4 to proceed from step 9.14 to step 9.12 and therefrom to proceed to other operations.

In step 9.16 the TAM 56 determines whether the record R associated with or stored partially or wholly within the card media 32 has sufficient credits stored of the credit type to consummate the expenditure requested in step 9.8. When the TAM 56 determines the record R associated with or stored partially or wholly within the card media 32 has sufficient credits stored of the credit type to consummate the expenditure requested in step 9.8, the TAM 56 directs the computer 4 to proceed on from step 9.16 and to execute step 9.18. In step 9.18 the credit quantity, e.g., the first credit quantity R.C.2 or R.D.2, is reduced to reflect the consummation of the credit expenditure request of step 9.8.

When the TAM 56 determines in step 9.16 that the record R associated with or stored partially or wholly within the card media 32 does not have a sufficient quantity of credits of a type valid to consummate the requested expenditure, the TAM 56 directs the computer 4 to proceed from step 9.16 to step 9.12 and therefrom to proceed to other operations.

It is understood that the TAM 56 may inform the user by means of the display device 27 when the TAM 56 proceeds directly from step 9.10, 9.14, or 9.16 and to step 9.12 of the failure to consummate the requested expenditure of step 9.8 and the rationale of the TAM 56 for not consummating the requested expenditure of step 9.8.

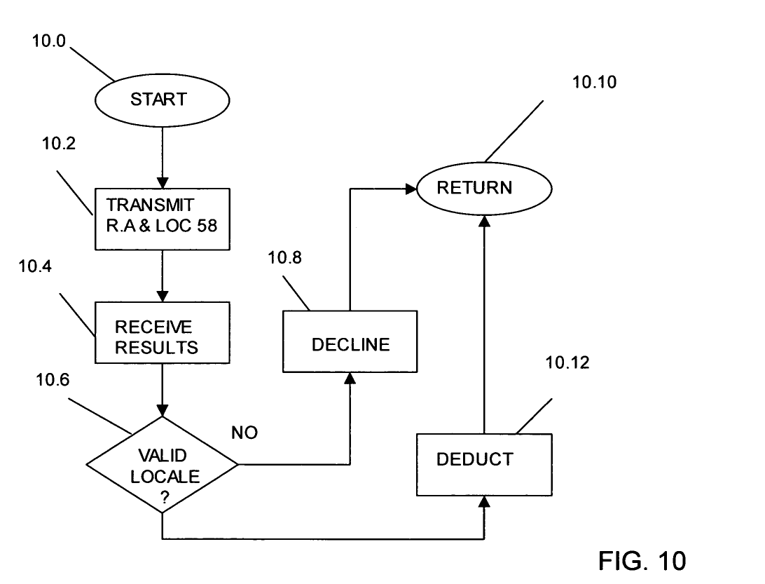

Referring now generally to the Figures and particularly to FIG. 10, FIG. 10 is a flow chart of an optional aspect of the TAM 56 of FIG. 9, wherein the computer 4 and a workstation 8 interact to decline or approve a requested credit expenditure of step 9.8 of the TAM 56. It is understood that the workstation 8 comprises the hardware and software aspects of the computer 4 of FIGS. 2 through 12. In step 10.2 the computer 4 transmits the account identifier R.A and a location datum 58, hereafter “LOC” 58, of the computer 4 to the workstation 8 via the network 2. The LOC 58 may be or include a zip code, a postal code, a global positioning datum, and/or a longitude and latitude datum that approximates or signifies the location of the computer 4 at the time the card 52 is presented to the media writer/reader 22. In step 10.4 the computer 4 receives a result of an approval process of the expenditure request of step 9.8, wherein the workstation compares the account identifier R.A and the LOC 58 to determine whether the account R.A has any accounts R.G or R.H or credits R.B, R.C.2, or R.D.2 that may be expended at the locale associated with the LOC 58 of the computer 4. In step 10.6 the computer 4 determines whether the workstation 8 has determined that the account identifier R.A is identifies a record R that is associated with an account R.G or R.H, or stores credits R.B, R.C.2, or R.D.2, that may be expended to consummate the expenditure request of step 9.8. Where the computer 4 determines in step 10.6 that the workstation 8 has determined that the account identifier R.A does not identify a record R that is associated with an account R.G or R.H, or stores credits R.B, R.C.2, or R.D.2 that may be expended to consummate the expenditure request of step 9.8, the computer 4 declines the instant expenditure request and proceeds on to step 10.10 to perform other operations.

Where the computer 4 determines in step 10.6 that the workstation 8 has determined that the account identifier R.A does identify a record R that is associated with an account R.H or R.H, or stores credits R.B, R.C.2, or R.D.2, that may be expended to consummate the expenditure request of step 9.8, the computer 4 proceeds from step 10.6 to step 10.12 and deducts the credits from the record R necessary to enable the requested transaction of step 9.8 of credit expenditure as compensation for a card bearer's receipt of a good or service.

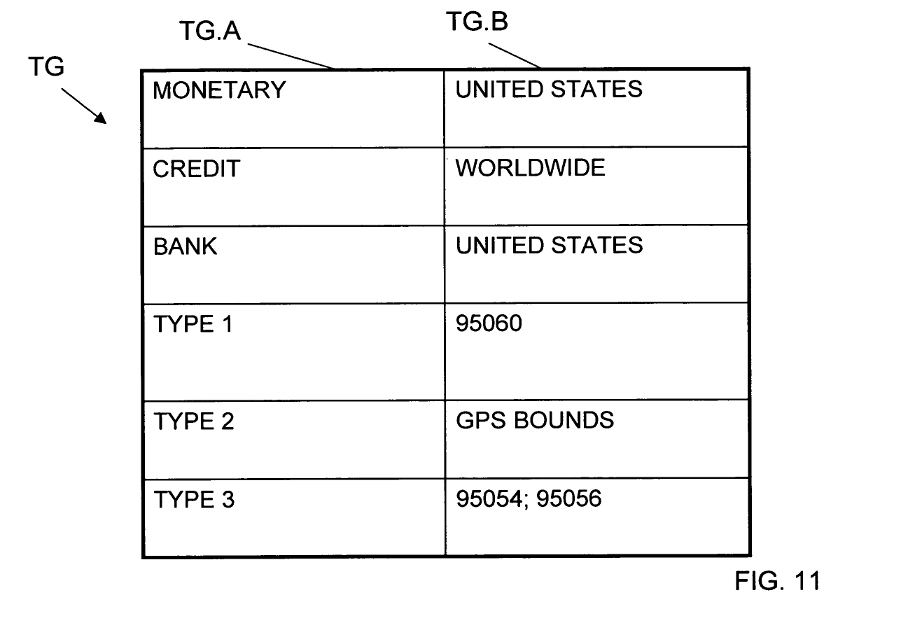

Referring now generally to the Figures and particularly to FIG. 11, FIG. 11 is a geographic table TG, or geo table TG, that may be used by the computer 4, a database system 6, a workstation 8, or the network 2 in enabling or supporting the process of the second method and/or FIG. 9. The geo table TG includes a type listing TG.A of credit types associated with individual accounts or credit types, such as the monetary value R.B and the first credit type R.C.1, and a geography listing TG.B of valid a geography wherein an associated credit type may be expended in compensation for receipt of a good or a service and in accordance with the second method. For example, a monetary value R.B may be expended within a political geography, e.g., the United States. Alternatively, a credit card account R.G might be available for access worldwide and in accordance with the second method. In further example, the first credit type R.C.1 might be expendable in accordance with the second method within a given zip code of 95060. Additionally or alternatively, the second credit type R.D.1 might be expendable in accordance with the second method within an are comprised within an area defined by global position system data or longitudinal and latitudinal specifications. In yet another example, a third credit type might be expendable in accordance with the second method within a plurality of zip codes, e.g. 95054 and 95056.

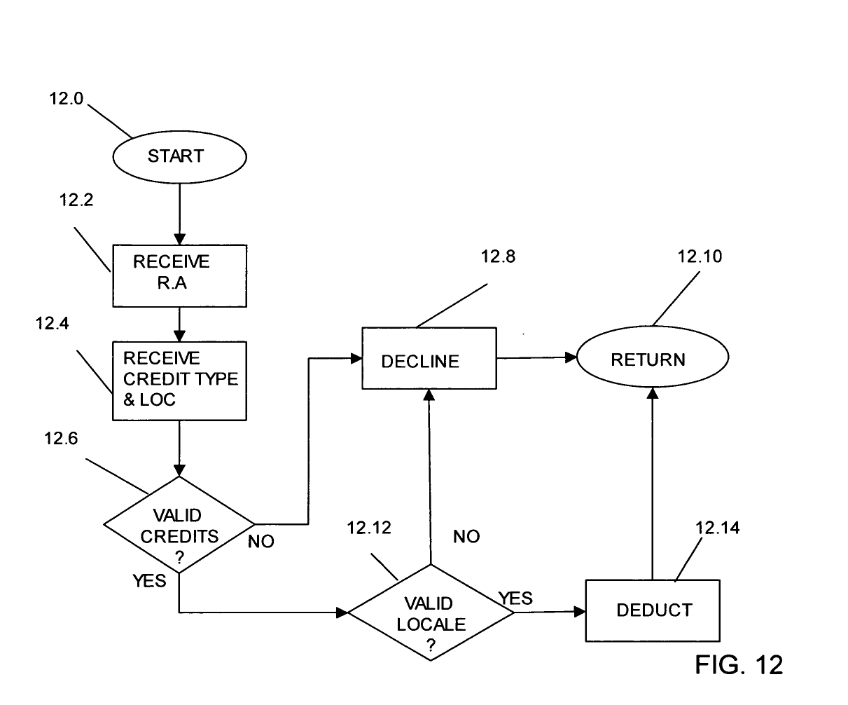

Referring now generally to the Figures and particularly to FIG. 12, FIG. 12 is a flow chart of optional process steps that may be implemented by the TAM 56. In step 12.2 an account identifier R.A is received by the computer 4, a workstation 8, or a database system 6. In step 12.4 the LOC 58 of the computer 4 where the card 52 is presented to the media writer/reader 22 is accessed by the TAM 56. In addition, in step 12.4 an account identifier R.G or R.H or a credit type R.B, R.C.1, or R.D.1 is also provided to the TAM 56. In step 12.6 the TAM 56 compares the account identifier or the credit type R.B, R.C.1, or R.D.1 and the LOC 58 accessed in step 12.4 and examined to determine whether the requested transaction of step 9.8 may be consummated with the provided account or credit information of step 12.4. When the account R.G or R.H or the credit type R.B, R.C.1, or R.D.1 identified in step 12.4 is not valid for the requested transaction of step 9.8, the TAM 56 directs the computer 4, workstation 8 or database system 6 of step 12.2 to proceed from step 12.6 to step 12.8 and to decline the requested transaction. The TAM 56 then proceeds from step 12.8 to step 12.10 and to other operations. When the account R.G or R.H or the credit type R.B, R.C.1, or R.D.1 identified in step 12.4 is determined to be valid by the TAM 56 for the requested transaction of step 9.8, the TAM 56 directs the computer 4, workstation 8 or database system 6 to proceed from step 12.6 to step 12.12.

In step 12.12 the computer 4, workstation 8 or database 6 of step 12.2 compares the account identifier R.G or R.H or the credit type R.B, R.C.1, or R.D.1 and the LOC 58 accessed in step 12.4 against the geo table TG to determine whether the account identifier R.G or R.H or the credit type R.B, R.C.1, or R.D.1 may be expended in a location that includes the locale identified by the LOC 58. When the TAM 56 determines that the account identifier R.G or R.H or the credit type R.B, R.C.1, or R.D.1 may be expended in a location that includes the locale identified by the LOC 58, the TAM 56 proceeds from step 12.14 to deduct from the instant account identifier R.G or R.H, or monetary value R.B or the credit type quantity R.C.2 or R.D.2 as required to consummate the requested transaction of step 9.8. The computer 4, workstation 8 or database system 6 executing the TAM 56 then proceeds from step 12.14 to step 12.10 and to other operations.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the Present Invention as disclosed and claimed should, therefore, be determined with reference to the knowledge of one skilled in the art and in light of the disclosures presented above.

I claim:

1. In a computer network, a method for managing purchasing values earned by purchasing goods and services from a plurality of subscribing merchants, the method comprising:
a. Assigning an account number:
b. Associating the account number with an object;
c. Issuing purchasing values as earned by purchasing associated with the assigned account number at least one of the subscribing merchants; and
d. Enabling the expenditure of the earned purchasing values in exchange for goods or services within a predetermined geography.

2. The method of claim 1, wherein the expenditure of the earned purchasing values requires physical presentation of the object at a merchant location within the predetermined geography.

3. The method of claim 1, wherein the object includes a machine readable memory, and the account number and issued purchasing values are written into and machine readable from the memory.

4. The method of claim 1, wherein the subscribing merchant earns advertising services in return for issuing purchasing values.

5. The method of claim 1, wherein the assigned account number is associated with a unique database record, and the issued purchasing values associated with the assigned account number are recorded in the unique data base record.

6. The method of claim 1, wherein at least one subscribing merchant issues uniquely identifiable purchasing values, and the expenditure of the uniquely identifiable purchasing values is limited to the purchases of goods and services marketed by the at least one subscribing merchant.

7. The method of claim 6, wherein the expenditure of the uniquely identifiable purchasing values is limited to the purchases of goods and services marketed at a retail sales location of the at least one subscribing merchant.

8. The method of claim 7, wherein the expenditure of the uniquely identifiable purchasing values is limited to the purchases of goods and services marketed at only one retail sales location of the at least one subscribing merchant.

9. The method of claim 1, wherein the purchasing values comprise at least two types:
a. A first type that may be exchanged for goods and services with all subscribing merchants; and
b. A second type that may be exchanged at a subset of all subscribing merchants.

10. The method of claim 9, wherein the expenditure of the second type of purchasing values is limited to the exchange of goods and services marketed at a retail sales location of the at least one subscribing merchant.

11. The method of claim 9, wherein the expenditure of the second type of purchasing values is limited to the exchange of goods and services marketed at a retail sales location of only one subscribing merchant.

12. The method of claim 10, wherein the expenditure of the second type of purchasing values is limited to the exchange of goods and services marketed at only one retail sales location of the at least one subscribing merchant.

13. In a computer network having a purchasing value data base and a computer, a method for exchanging purchasing values, the method comprising:
a. Assigning a plurality of unique account numbers:
b. Associating each account number with a unique physical card and a unique database record of the purchasing value data base;
c. Storing purchasing values assigned to each unique account number in each associated unique data base record
d. Programming the computer to automatically effect transfers of purchasing values at least two unique database records; and
e. Enabling the transfer of purchasing values among each unique data base records as the computer is programmed in step d.

14. The method of claim 13, further comprising enabling the expenditure of the earned purchasing values in exchange for goods services within a predetermined geography.

15. The method of claim 14, wherein at least one unique database record includes permission to automatically exchange purchase values.

16. The method of claim 15, wherein the at least one unique database record includes permission to automatically exchange purchase values issued by an identified subscribing merchant.

17. The method of claim 16, wherein the at least one unique database record includes permission to automatically exchange purchase values for purchase values issued by an identified subscribing merchant.

18. The method of claim 15, wherein the purchasing values comprise at least two types:
a. A first type that may be exchanged for goods and services with all subscribing merchants; and
b. A second type that may be exchanged at a subset of all subscribing merchants.

19. The method of claim 18, wherein the expenditure of the second type of purchasing values is limited to the exchange of goods and services marketed at a retail sales location of the at least one subscribing merchant.

20. The method of claim 19, wherein the expenditure of the second type of purchasing values is limited to the exchange of goods and services marketed at a retail sales location of only one subscribing merchant.

21. The method of claim 13, further comprising enabling automated transfer of purchasing values in accordance with user directed preferences of types of purchasing values.

22. A computer-readable medium, the computer-readable medium containing machine-executable instructions for directing an information technology system to execute the method of claim 1.
